(19) United States
(12) Patent Application Publication
(10) Pub. No.: US 2021/0283796 A1
(43) Pub. Date: Sep. 16, 2021

(54) Apparatus and Method for Causing Oscillating Motion of a Saw Blade, a Saw Blade, and a Method of Attaching a Saw Blade

(71) Applicant: Genius IP Limited, Edgware (GB)

(72) Inventor: Teklemichael Sebhatu, London (GB)

(21) Appl. No.: 16/478,117

(22) PCT Filed: Nov. 1, 2017
(86) PCT No.: PCT/GB2017/053295

§ 371 Date: Jul. 15, 2019

(30) Foreign Application Priority Data
Jan. 11, 2016 (GB) 1618450.9
May 2, 2017 (GB) 1706891.7

(51) Int. Cl. B27B 19/00; B23D 49/00; B23D 51/16; B23D 61/00

(52) U.S. Cl. CPC B27B 19/008; B23D 61/006; B23D 51/16; B23D 49/003

(57) ABSTRACT

Apparatus comprising: a rotatable drive shaft (12): one or more members (16a-d) mounted for oscillators, pivoting motion: motion conversion means (17, 28a-d, 16a-d) for convening rotational motion of the drive shaft to the oscillatory, pivoting motion of the one or more members: means coupling the or each member and one or more saw blades (14a-f) so that the oscillatory motion of the one or more member causes oscillatory cutting action of the or each blade. There is also provided a saw blade, and a method of attaching a saw blade.

### FIELD OF THE INVENTION

The invention relates to apparatus configured to provide oscillating motion to a saw blade. The invention also relates to a saw blade for use with a sawing device, and a method of attaching such a saw blade to the sawing device.

### BACKGROUND

Plasterboard, also known as drywall, gypsum board or wallboard, is a panel made of gypsum plaster pressed between two thick sheets of paper. Plasterboard panels are typically mounted on structural members to make interior walls and ceilings of buildings. It is sometimes necessary, particularly when a building is erected, to cut openings in plasterboard to provide access to electrical switch and outlet boxes mounted on the structural members. An opening may be cut before the plasterboard is mounted on the structural members, or it may be necessary to cut the opening while the plasterboard is in situ mounted on the structural members.

The usual process of cutting openings comprises firstly marking on the plasterboard where the opening is to be cut. Then, a workman cuts the opening using a saw. The opening typically has rough edges. This process is time consuming, typically taking a practised workman 15 to 30 minutes. The process is also error prone and typically makes a mess. Also, the saw can extend beyond the plasterboard to make contact with an object on the far side of the plasterboard from the workman. This can cause damage to the object Since there may be electrical wiring, this also presents danger to the workman.

A known document, U.S. Pat. No. 3,503,294, describes a sawing apparatus. This sawing apparatus includes a crank member that is coupled to a rotational power source. Sawing action of four blades is driven by eccentric movement of the crank member. The sawing apparatus is unstable in use, which may lead to a user applying different blades to an object to be cut at different pressures. This may disadvantageously lead to the object being cut more quickly in some regions than in others. In addition, the eccentric motion of the crank causes vibration of the device. The issues of instability and vibration make the apparatus difficult and unpleasant to use, and may lead to unsatisfactory and inaccurate cutting.

The inventor has previously sought patents via a patent application entitled “Convening Between Rotary and Linear Motion, and a Sawing Device”, published under number WO2013057511. This publication includes disclosure of a sawing device for cutting by simultaneous cutting action of four saw blades on a surface of an object to be cut. Each saw blade is attached to a respective blade carrying part. Each blade carrying part can move back and forth parallel to the required path of movement of the respective saw blade. A motion conversion mechanism is provided to convert rotary motion of a drive shaft to reciprocating movement of each blade carrying part. The reciprocating movement of each blade carrying part causes the required reciprocating culling movement of the corresponding blade.

While this sawing device was a considerable improvement over previous sawing devices intended for the same purpose, the sawing device did not allow cutting of an aperture in plasterboard as quickly as the inventor wanted, still vibrated more than was wanted, and required more force than was wanted to push the blades into the surface of the object to be cut. It is an object of the present invention to address these issues.

### SUMMARY OF THE INVENTION

In accordance with a first aspect of the present invention, there is provided apparatus comprising: a rotatable drive shaft: one or more members mounted for oscillatory, pivoting motion: motion conversion means for converting rotational motion of the drive shaft to the oscillatory, pivoting motion of the one or more members: means coupling the or each member and one or more saw blades so that the oscillatory motion of the one or more member causes oscillatory cutting action of the or each blade.

Optional and/or preferred features of the first aspect are set out in the dependent claims.

In accordance with a second aspect of the present invention, there is provided a saw blade for attaching to a sawing device including a first member and a second member, the saw blade comprising: a cutting edge portion: a mounting structure coupled with and spaced apart from the cutting edge portion, and configured for mounting of the saw blade on the sowing device using the first member and the second member, wherein the mounting structure comprises first and second limbs joined at ends nearer the cutting edge portion by a base, and extending away from the cutting edge portion, wherein the first and second limbs are arranged to provide a space between the limbs, wherein the space comprises: a first region including an opening between free ends of the first and second limbs, and having a width of at least a first width: a second region wider than the first width, such that, when the first member is located in the second region and the first member has a width greater than the first width, the saw blade cannot be separated from the mounting structure by movement longitudinal relative to a length of the first and second limbs, a third region defined in part by the base, in which at least a part of the second member can be located, wherein the third region allows the at least a part of the second member to be located therein following movement of the at least a part of the second member through the first and second regions, wherein, in use, when the base abuts the second member, the second region is located in a predetermined location relative to the first member so that a least a portion of the first member located having a width greater than the first width can locate in the second region.

In accordance with a third aspect of the present invention, there is provided apparatus as defined in a method of attaching a saw blade to a sawing device, wherein the sawing device has a first member and a second member, wherein the saw blade includes a mounting structure comprising a pair of limbs extending transversely relative to a cutting edge of the saw blade, wherein the pair of limbs define a space between the limbs, and wherein the first member is reconfigurable between a second width less than or equal to a first width and a third width greater than the first width, the method comprising operating the sawing device to configure the first member to have the second width, relatively locating the saw blade and the first and second members, when the first member has the second width, by moving the first and second members longitudinally relative to the limbs through a first region of the space, which includes an opening between free ends of the limbs and has a minimum width of the first width, so that at least a part of the second member is located in a third region of the space, and the first member is located in a second region of the space: operating the sawing device to reconfigure the first member to have the third width, whereby the blade cannot be separated from the mounting structure by movement longitudinal relalive to the first and second limbs, and whereby the at least a part of the second member prevents movement of the first member into the third region.

In accordance with a fourth aspect of the present invention, there is provided a sawing device comprising a rotatable drive shaft: motion conversion means for converting rotational motion of the drive shaft to the oscillatory motion of a plurality of blades, wherein the blades are configured to simultaneously provide cut lines in a surface of an object to be cut in a square or rectangular formation: a drill bit attachment rotatably coupled to the drive shaft, wherein, a drill bit, operatively attached to the drill bit attachment, is configured so that, when the blades are pressed against the surface, the drill bit pierces the surface thereby to anchor the sawing device when cutting. Such a sawing device may comprise the apparatus of the first aspect of the invention, and any of its optional preferred features.

In accordance with a fifth aspect of the present invention, there is provided a sawing device may be configured to provide one or more cut lines in a wall at a selected height, comprising a measuring means having an end for location against a floor adjacent the wall thereby to enable the cut lines to be made at the selected height. The measuring means may include an indication of a predetermined height. The sawing device may further comprise a handle, wherein the measuring means is collapsible within the handle. The handle may be detachable.

In accordance with a sixth aspect of the invention, there is provided a saw blade for attaching to a sawing device, comprising, a convexly curved cutting edge portion: a mounting structure coupled with and spaced apart from the cutting edge portion, wherein the saw blade is configured for culling by oscillating motion about a pivot point in the mounting structure: therein the cutting edge portion is shaped so that, when the saw blade is oscillated over a predetermined angle to cut into a flat surface, a cut line can be formed of substantially uniform depth. The predetermined angle may be from 9 degrees to 15 degrees. The predetermined angle may be from 10 degrees to 14 degrees. The predetermined angle may be from 11 to 13 degrees.

The cutting edge portion and the mounting structure may be co-planar. The first and second limbs may extend away from the cutting edge from a mid-region thereof in a transverse manner. A length of a space between the limbs may extend away from a mid-region of the culling edge in a transverse manner. The saw blade may be 68 mm to 70 mm, 128 mm to 150 mm, 95 mm to 97 mm or 48.5 mm to 50.5 mm. The mounting structure may be configured to attach to the sawing device so that the saw blade can be oscillated about the pivot point. The blade may be at least 48 mm in length, optionally at least 68 mm in length, optionally at least 95 mm in length, optionally at least 128 mm in length. The saw blade may be from 68 mm to 70 mm, 128 mm to 130 mm, 95 mm to 97 mm or 48.5 mm to 50.5 mm. The features of the second and fifth aspects in particular may be combined.

### BRIEF DESCRIPTION OF THE FIGURES

For better understanding of the present invention, embodiments will now be described, by way of example only, with reference to the accompanying Figures in which:

FIG. 1 is perspective view of a sawing device and a detached handle in accordance with embodiments of the invention:

FIG. 2 is a perspective view of the sawing device shown in FIG. 1, with an outer housing and some other parts removed:

FIG. 3 is an exploded view of the sawing device shown in FIG. 1:

FIG. 4 is perspective view of the sawing device with the handle attached:

FIG. 5 is a cross-sectional view through the section indicated at A-A in FIG. 4:

FIG. 6 is a cross-sectional view through tin: section indicated at B-B in FIG. 4:

FIG. 7 is a view of parts of the sawing device, including a cylindrical block and drive shaft:

FIG. 8 is a view of a part of the sawing device, comprising a guide cage:

FIG. 9 is an exploded perspective view of pans of the sawing device, particularly for use in attaching a blade to the sawing device:

FIG. 10 is an exploded perspective view of other parts of the sawing device, particularly for use in attaching a blade to the sawing device:

FIG. 11 is a perspective view of a blade for use with the sawing device.

### DETAILED DESCRIPTION OF EMBODIMENTS

Like reference numerals are used to denote like parts throughout.

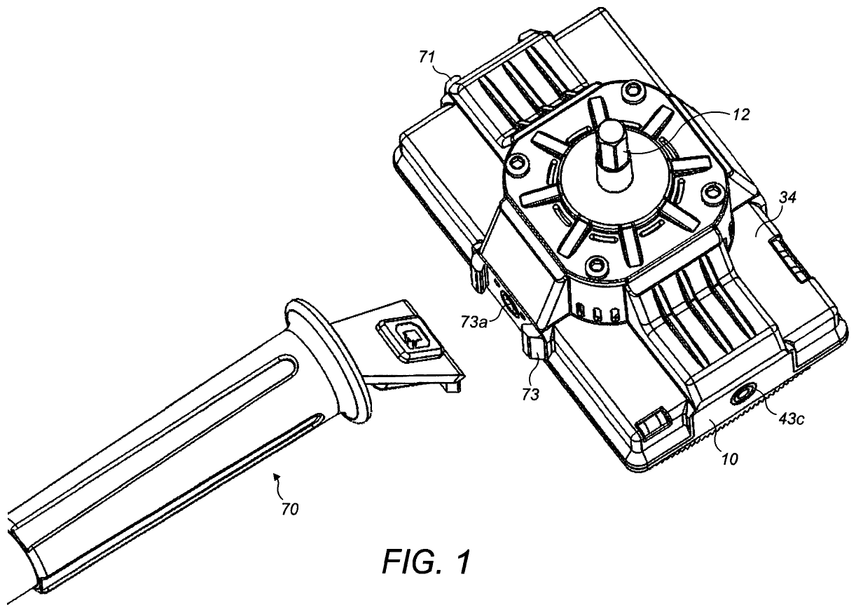

Generally, the sawing device is suitable for cutting a predetermined shape, particularly a square or a rectangular shape, by causing a simultaneous repetitive cutting action or four blades on a substantially flat surface of an object, such as plasterboard, to be cut. Referring initially to FIGS. 1 to 6, in accordance with an embodiment the sawing device comprises a support structure 10, a rotary drive shaft 12, saw blades, a motion conversion arrangement (or converting rotary motion of the drive shall 12 to oscillatory motion of first, second, third and fourth oscillating walls 16a-d, and first, second, third and fourth coupling assemblies for respectively attaching the blades and for transmitting the oscillatory motion of the first, second, third and fourth oscillating walls 16a-d to the blades.

The coupling assemblies have six blade retention assemblies providing six places at which a one of the blades can be attached. The blade retention assemblies are arranged so that the blades can be disposed to cut an arrangement of square cut lines or an arrangement of rectangular cut lines. Some of the Figures show the sawing device with six blades for illustration purposes only, while other Figures show four blades, which is the number of blades that are attached when the sawing device is in use. The blades are indicated at 14a-f. Longer or shorter versions of the blade 14a, 14b may be attached and the same reference numeral is used in both cases.

The drive shaft 12 is rotatable about a central axis thereof. The motion conversion arrangement includes a generally cylindrical block 17 integrally formed with the drive shaft 12 and coaxial therewith, such that rotation of the drive shaft 12 causes rotation of the cylindrical block 17.

In variant embodiments, the cylindrical block 17 is not integrally formed with the drive shaft 12, but is separately formed and mounted on the drive shaft 12. To enable such mounting, a section of the surface of the drive shaft 12 may be splined, and the cylindrical block 17 may have an aperture extending through it, an interior surface of which is correspondingly spiined, so as to allow the cylindrical block to be mountable on the drive shaft 12 and so that relative rotational movement about the central axis is prevented.

The motion conversion arrangement also includes a continuous groove 22 in a circumferential outer surface of the cylindrical block 17, first, second, third and fourth linking ball support slots 24a-d, the first, second, third and fourth oscillating walls 16a-d and first, second, third and fourth linking balls 28a-d. The first, second, third and fourth linking ball support slots 24a-d are provided by a cylindrical guide cage 25 that extends around the cylindrical block 17 and is coaxial therewith. The guide cage 25 is best seen in FIG. 8.

A first end 12a of the drive shaft 12 has a hexagonal cross-section and is configured in the same manner as an attachment part of a conventional drill bit. Thus the first end can conveniently be attached to an electric drill and the electric drill operated to cause rotation of the drive shaft 12. In variant embodiments, the first end 12a is configured for attachment to other tools or devices operable to cause the drive shaft 12 to rotate. In other embodiments that are not shown, the sawing device includes an integrated electric motor operable to drive rotation of the drive shaft 12.

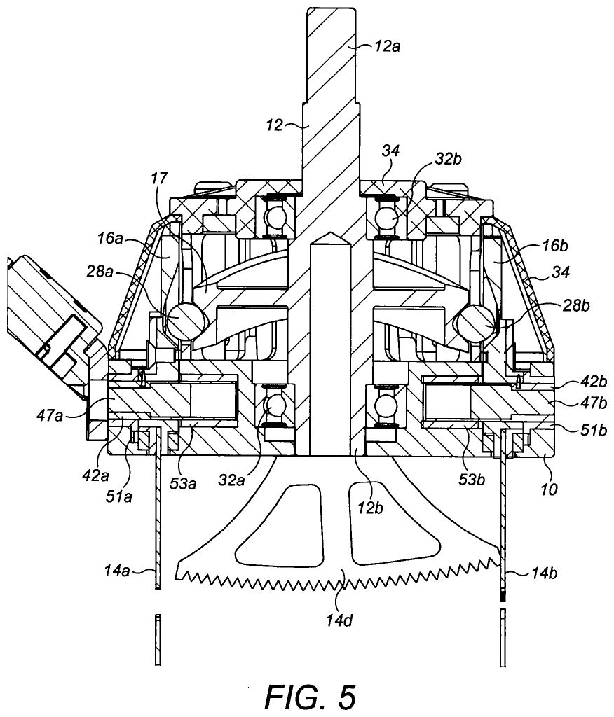

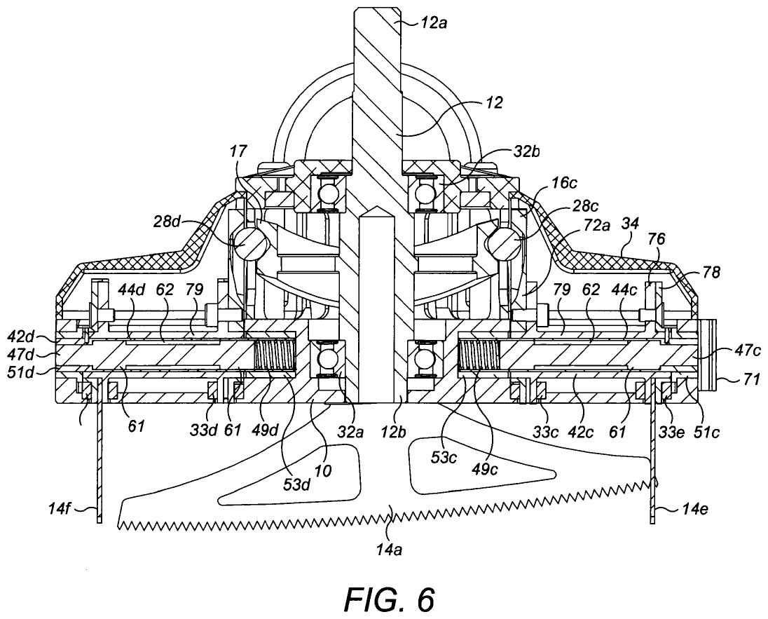

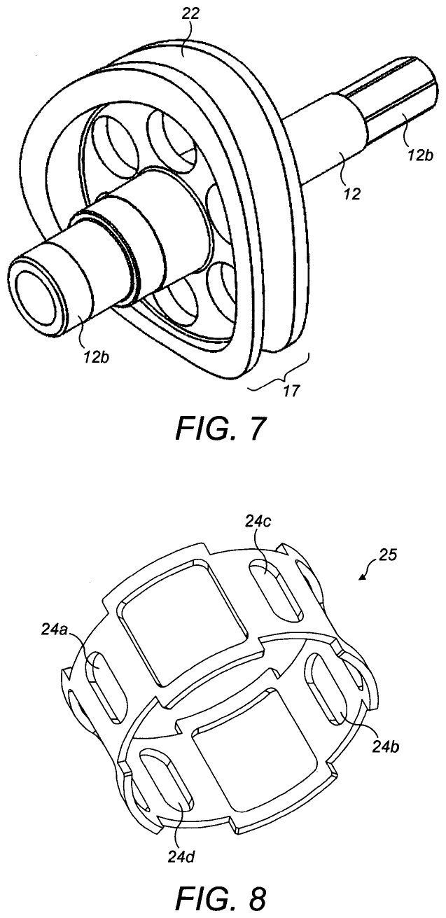

A second end 10b of the drive shaft 12 extends beyond the cylindrical block 17. As best seen in FIGS. 5 and 6, first and second annular bearing assemblies 32a. 32b are located between the drive shaft 12 and, respectively, the support structure 10 and an outer housing 34, to retain the drive shaft 12 so that its central axis is in a fixed position relative to the support structure 10, and so that the drive shaft 12 and the cylindrical block 17 can freely rotate about the central axis.

The continuous groove 22 extends around the cylindrical block 17 in a wave-like manner. The continuous groove 22 has one peak and one trough. In variant embodiments, the continuous groove 22 may have more than one peak and, correspondingly, more than one trough. The chosen number of peaks and troughs may be dependent on the speed at which the drive shaft 12 is rotated. The radial distance of the continuous groove 22 from a central axis of the cylindrical block 20 is constant over the length of tire continuous groove 22.

The first, second, third and fourth linking ball support slots 24a-d are spaced around the cylindrical block 17 at degree intervals, each being an equal distance from the groove 22. The first, second, third and fourth support slots 24a-d respectively retain the first, second, third and fourth linking balls 28a-d, so as to permit back and forth movement in the corresponding slot. The first, second, third and fourth support slots 24a-d are arranged so that back and forth movement of the linking balls 28a-d is in a direction parallel to the central axis of the cylindrical block 17. Each of the first, second, third and fourth support slots 24a-d have first and second open sides, the first side facing the cylindrical block 17 and the second side facing the corresponding one of the first, second, third and fourth oscillating walls 16a-d.

The first, second, third and fourth coupling assemblies each comprise pivot pieces in the form of first, second, third and fourth sleeves 42a-d. The first, second, third and fourth oscillating walls 26a-d are fixedly mounted for pivoting movement on the first, second, third and fourth sleeves 42a-d, respectively. Each of the first, second, third and fourth oscillating 26a-d has a surface facing the second side of the corresponding one of the first, second, third and fourth support slots 24a-d. the surface having a respective force transmission groove 30a-d therein. Each force transmission groove 30a-d is in a straight line, although it need not be. Each force transmission groove 30a-d extends non-radially with respect to a point about which the respective oscillating wall 26a-d pivots.

The continuous groove 22, the first, second, third and fourth support slots 24a-d and the first, second, third and fourth linking balls 28a-d are respectively sized and arranged so that a first portion of each of the first, second, third and fourth balls 2Sa-d protrudes from the find side of the respective first, second, third and fourth support slot 24a-d into the continuous groove 22. The cylindrical block 20 is rotatable to cause the continuous groove 22 to move the first, second, third and fourth linking balls 28a-d back and forth in the first, second, third and fourth support slots 24a-d, respectively.

The first, second, third and fourth oscillating walls 16a-d, the first, second, third and fourth support slots 24a-d and the first, second, third and fourth linking balls 28a-d are respectively sized and arranged so that a second portion of each of the respective first, second, third and fourth balls 28a-d protrudes from the second side of the first, second, third and fourth support slots 24a-d into the corresponding force transmission groove 30a-d The force transmission groove 30a-d is positioned in the corresponding one of the first, second, third and fourth oscillating walls 26a-d so that back and forth movement of the linking ball 2″a-d in the first, second, third and fourth support slots 24a-d causes corresponding rocking movement of the linking wall 26a-d about the central axis of, respectively, the first, second, third and fourth outer sleeves 42a-d.

As already mentioned, the sawing device has six blade retention assemblies providing six places at which a one of the blades 14a-f can he attached. A first 44a of the blade retention assemblies is mounted on the first sleeve 42a, a second 44b of the blade retention assemblies is mounted on the second sleeve 42b, third 44c and fifth 44c of the blade retention assemblies are mounted on the third sleeve 42c, and fourth 44d and sixth 44f of the blade retention assemblies are mounted on the fourth sleeve 42d. Each of the blade retention assemblies 44a-f is configured so that a blade can be attached and removed via a respective slit 40a-f in the support structure 10. The first, second, third and fourth blade retention assemblies 44a-d are arranged at regular intervals around and equally spaced from live central axis of the cylindrical block 17, as first and second opposing pairs, the first pair comprising blade retention assemblies 44a,b, and the second pair comprising blade retention assemblies 44c,d. Four blades, when attached to the first and second pairs of blade retention assemblies, are disposed as two pairs (14a. 14b: 14c, 14d) of parallel blades, the pairs being mutually perpendicular, so that the sawing device can be used to cut a substantially square arrangement of cut lines. These four blades are the same length (“first length”).

In addition to the four blade retention assemblies arranged at regular intervals around the cylindrical block 17, a third pair 44e,f of the six blade retention assemblies, comprising the fifth and sixth blade retention assemblies 42e,f is located further away from the cylindrical block 17 than the second pair of blade retention assemblies. Each of the fifth and sixth blade retention assemblies 44e,f is configured so that, an attached blade is disposed perpendicular to blades held by the first pair of blade retention assemblies 44a,b. Each or the blade retention assemblies 44e,f of the third pair holds, in use, a blade of the first length. When the blade retention assemblies 44e,f of the third pair are used, no blades are attached to the second pair of blade retention assemblies and a blade having a second length, longer than the first length, is attached to each of the first pair 44a,b of blade attachment assemblies. The second length is such that the formation of blades of the first length attached to the third pair 44e,f of blade retention assemblies, and the blades of the second length attached to the first pair of blade retention assemblies 44a,b allows the sawing device to be used to cut a substantially rectangular arrangement of cut lines.

The first pair of blade retention assemblies 44a,b are mounted on the first and second sleeves 42a,b and the second and third pairs of blade retention assemblies 44c-f are mounted on the third and fourth sleeves 42c,d, such that part rotational movement of the first, second, third and fourth sleeves 42a-d about a respective central axis sleeve causes corresponding pivoting movement of the blade retention assemblies 44a-f and the blades. Each sleeve 42a-d has a respective pin 4″a-d therein.

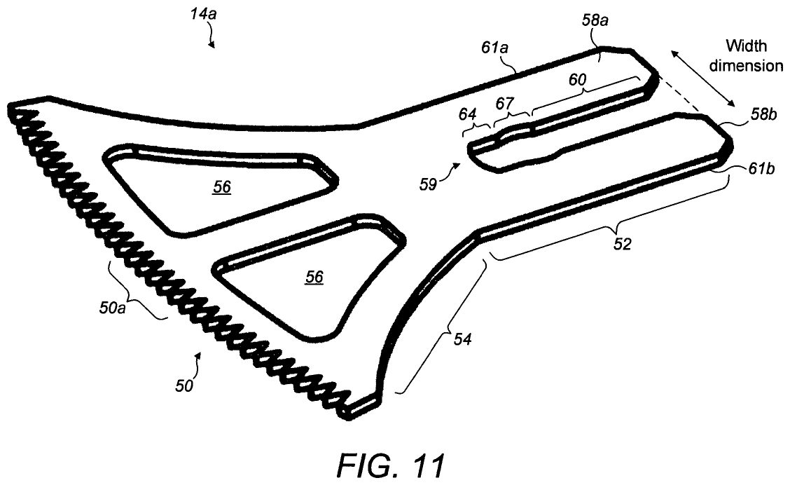

The blades will now be described in detail with reference to FIG. 11, which shows an example of the first blade 14a of the first length suitable for attachment to each of the blade retention assemblies 44e,f of live third pair when a rectangular formation of cut lines is wanted, or to each of the blade retention assemblies 44a-d of the first and second pair, when a square formation of cut lines is wanted. The longer blade 14b has an identical attachment part.

The blade 14a comprises a planar, rigid piece of uniform thickness, having a first end having a comedy curved, serrated cutting edge 50, and a second end in the form of an attachment part 52. The cutting edge 50 and the attachment part 52 are coupled by a shank portion 54. The shank portion 54 has a pair of cut out portions 56 in the blade. to save on material and reduce weight.

The attachment part 52 comprises first and second limbs 58a, 58b that extend away from the cutting edge 50. More specifically, the first and second limbs 58a, 58b extend away from a central region 50a of the cutting edge 50 in a crosswise manner. That is, a direction in which the first and second limbs 58a, 58b extend is substantially transverse relative to a tangent to the cutting edge 50 at the central region 50a.

The attachment part 52 also includes a base portion 59 joining the limbs 58a,b. Each limb has an outer edge 61a, 61b defining a width for the attachment part. These outer edges 61a, 61b are straight and parallel, but they might alternatively be sloped with the attachment part 52 tapering away from the cutting edge 10. Generally, the interior space of the blade retention assemblies are dimensioned so that the blade 16a,b can be inserted into the interior space, but cannot move laterally. Thus, the defined width is preferably the same width as the width of the interior space of the blade retention assembly, such that movement in the direction of the width is prevented. Also, the thickness of the interior space is the same as the thickness of the material of the limbs 58a, 58b, such that the attachment part cannot move in the direction of the thickness of the interior space.

The limbs 58a, 58b define a pin-receiving space between them the purpose of which is attaching the blade 14a,b to the blade retention assemblies 44a-f so that the attached blade does nut come loose. The pin-receiving space comprises three regions.

A first region 60 includes a mouth between free ends of the limbs 58a,b. The first region 60 also has a first width denned by a distance between parallel portions of interior side edges of the limbs 58a,b, except at the mouth where the free ends of the limbs 58a,b are bevelled. A second region 62 is formed of opposing concave recesses in interior side edges of the limbs 58a,b. The concave recesses are part-circular in curvature. Although the width of second region varies, its width (“second width”) is greater than the first width. A third region 64 is provided by another portion of the limbs 58a,b and the base portion 59. A length of the pin-receiving space extends away from a mid-point of the cutting edge.

The cutting edge 50 is shaped so that, when the saw blade is oscillated about a pivot point in the attachment part 52, to cut into a flat surface, a cut line of substantially uniform depth is formed. The pivot point is in a centre of a notional circular of which the sides of the second recess 62 form part. A predetermined angle over which the blades are oscillated in a rocking action about the pivot point may be 12 degrees. This is 6 degrees to each side of a line orthogonal to the flat surface. An axis of the associated pin extends through the pivot point. In embodiments, the predetermined angle may be at least 9 degrees, preferably at least 10 degrees and more preferably at least 11 degrees. The predetermined angle may be less than 15 degrees, preferably less than 14 degrees, and more preferably less than 13 degrees. The curvature of the blades is configured dependent on the predetermined angle so that the depth cut is uniform.

In some embodiments, the first length of the saw blade is 68 mm to 70 mm, or 48.5 mm to 50.5 mm, and the second length is 128 mm to130 mm, or 95 mm to 97 mm, for example. The first and second lengths may be configured dependent on the size of an aperture that it is desired to cut. For example, the first and second lengths, and the sawing device, may be configured to cut holes for ventilation shafts or air conditioning units. The length of the saw blades may thus be at least 48 mm or at least 68 mm, or at least 95 mm or at least 128 mm. The length of the cut line is typically approximately 6 mm greater than the length of the respective saw blade: thus each blade extends approximately 3 mm to either side in use.

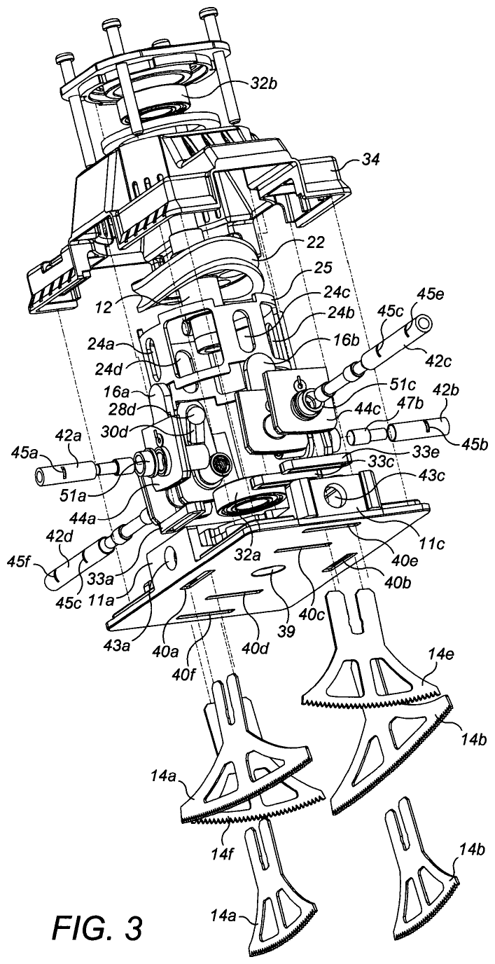

Referring in particular to FIGS. 3, 5 and 6, each sleeve 42a-d is mounted on the support structure 10 in a manner that allots at least partial rotational motion, that is, at least the motion that is caused by the oscillating movement of the first, second, third and fourth oscillating walls 26a-d. One end of each sleeve 42a-d, that is, the end nearer the guide cage 25, is mounted in a bushing 53a-d in a cylindrical recess (best seen in FIGS. 5 and 6) provided by the support structure 10, such that lateral movement of that end of the respective sleeve 42a-d is prevented. Support walls 11a-d having cylindrical apertures 43a-d extend from the support structure 10. The apertures 43a-d are each configured to receive a respective bush 51a-d and the other end of the respective sleeve 42a-d extends in the bush 51a-d, such that lateral movement of the other end is prevented. Thus, each of the sleeves 42a-d is held radially by the respective cylindrical recess and support wall 11a-d with respect to the central axis of the drive shaft 12, and the sleeves 42a-d extend at right angles with respect to adjacent ones of the sleeves 42a-d.

Each sleeve 42a-d has slits therein at opposing sides thereof at the one or two places where a blade is to be attached. Each slit 45a-f is transverse with respect to the length of the sleeve 42a-d and extends parallel to the drive shaft 12. The first and second sleeves 42a,b each have a single pair of slits 45a,b therein. The third and fourth sleeves 42c,d each have two pairs of slits therein, indicated at 45c-f, so that blades can be attached to these sleeves 42c,d at two different places. The slits are positioned on the sleeves 42a-f, and the sleeves 42a-f are positioned, so that the slits are accessible through the slots 40a-f in the support structure 10.

Each sleeve 42a-d with its slits 45a-f, and the attachment part of the blades, are configured that the sleeve 42a-d cannot be located between the limbs 58a,b other than by a portion of the limbs passing through the slits 45a-f, the portion including the opposing inner edges or the limb 58a,b defining the first region 62 Thus. The diameter of the sleeves 42a-d is generally greater than the first width defined between the opposing inner edges of the limbs 58a,b, but, where the slits are present, the respective sleeve 42-d presents a width slightly less than the first width. When located through the slits, the inner edges defining the first region 60 pass through the inside of the respective sleeve 42a-d. An internal diameter of the sleeve 42a-d corresponds to the diameter of the part-circular edges defining the second region 62.

Each sleeve 42a-d has a corresponding pin 47a-d that is moveable in the respective sleeve. The pins 47a-d are moveable between a blocking position in which a blade 14a-f with its attachment part appropriately located is secured, and an open position in which a blade can be attached or detached. The pins 47a-d are cylindrical in cross-section and have first and second portions of different diameters. The first portion 61, which has a larger diameter, is of a diameter that corresponds with the internal diameter of the sleeves. When a blade is located such that the second recess 62 and the interior surface of the respective sleeve 42a-d are aligned, the pin 47a-d is in a blocking position in the sleeve when the first portion of the pin 47a-d is located between the slits 45a-f. When the first portion 61 is in this position, the blade cannot be removed by action of the blade 14a-f away from the sawing device longitudinally with respect to the first and second limbs 58a,b, since the diameter of the first portion 61 is greater than the width of the first region 60 of the blade. If a blade is not attached, no blade can be attached when the pin 47a-d is in the blocking position since the limbs 58a,b cannot be located over the corresponding sleeves as the first portion blocks passage of the limbs through the slits. The first portion 61 is located along two portions on sleeves 42c,d, so that both pairs of slits on those slits can be blocked. When a blade is attached and the pin is in the blocking position, the first portion 61 extends through the second region 62 of the blade, preventing the blade being removed. When the pin is in the open position, a second portion 63 of the pin, which has a smaller diameter, is located between the slits, the limbs 58a,b can be located over the corresponding sleeve The Wade can then be fixed in position by movement of the pin into the blocking position.

When a blade is attached, a part of the corresponding sleeve occupies the third region 64 between the limbs 58a,b. Although not essential, the part of the sleeve and the base of the attachment part abut for stability of the blade. The third region 62 is also shaped with respect to the sleeves to define a maximum extent to which the attachment part is inserted.

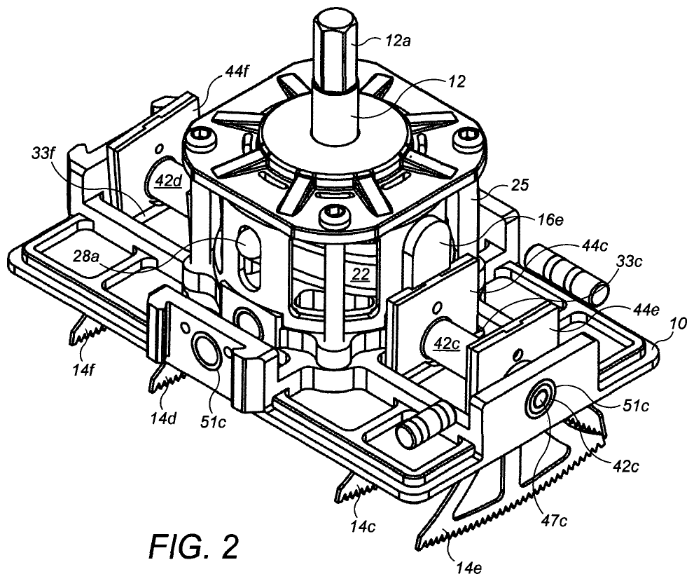

A resilient means in the form of a spring 49a-d is located in each sleeve 42a-d, to bias each pin into the blocking position. Each spring 49a-d is located in respective sleeve 42a-d between an end surface of the respective cylindrical recess in the support structure 10 and an end of the respective pin 47a-d. A shoulder in the interior of each sleeve 42a-d abuts against the other end of the respective pin to retain that pin 47a-d in the sleeve 42a-d against live corresponding spring 49a-d. Each pin may be pushed using a pointed tool through the corresponding aperture 43a-d to mow the pin from the blocking position to the open position against the spring, thereby to enable release or attachment of a blade. In FIG. 2, pins 47b and 47d are shown away from their in use location for illustrative purposes.

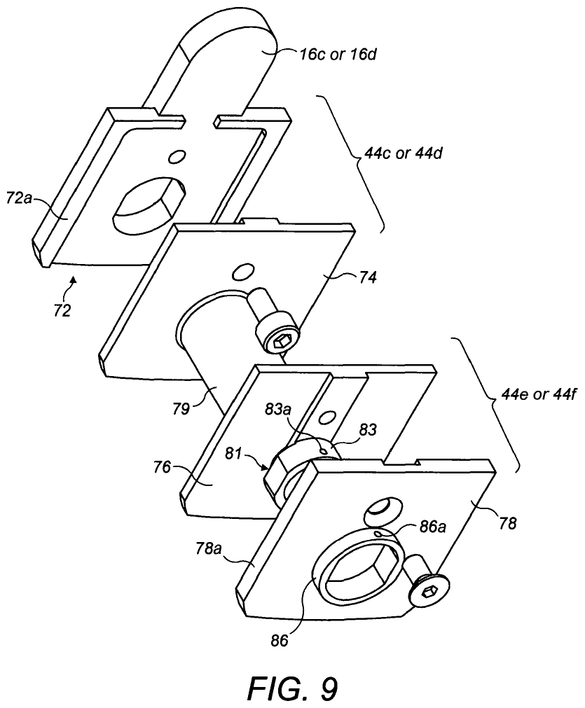

Referring to FIG. 9, the third and fifth blade retention assemblies 44c,e are coupled by a oversleeve 79 The third blade retention assembly 44c comprises a first plate part 72 and a second plate part 74 fixed together with a bolt to define an interior space into which the limbs of a blade can be located. The fifth blade retention assembly 44e also comprises a first plate part 78 and a second plate part 76 fixed together with a bolt to define an interior space into which the limbs of a blade can be located. The first plate parts 72, 78 each have a spacing wall 72a, 78a extending so that when the respective second plate part 74, 76 is fixed to the first plate parts 72, 78, the two pans are not flush and the interior space is defined. The first plate part 72 is integrals formed with live respective oscillating wall 16a-d. The dimensions of the interior space of each blade retention assembly aw such as to prevent lateral movement when the attachment part of the blade is inserted. The oversleeve 79 is sized to receive the third sleeve 42c. In the fifth retention assembly 44e a recess can be seen at 81 enabling the portion of the limbs of a blade defining the first region 60 to slide under an annular spacing piece 83. The same is provided on the hidden side of second plate part 44.

As can be seen at 83a and 86a in FIG. 9, a threaded hole is provided in the annular spacing piece 83 and an overlying fitting 86 enabling a bolt (not shown) to be screwed therethough. The bolt can be screwed against the respective sleeve running through the oversleeve 79, such that the blade retention assemblies and the sleeve are fixedly attached.

The fourth and sixth blade retention assemblies 44d,f, together with an respective connecting oversleeve 79, are con figured in an identical manner to the third and fifth blade retention assemblies 44c,f.

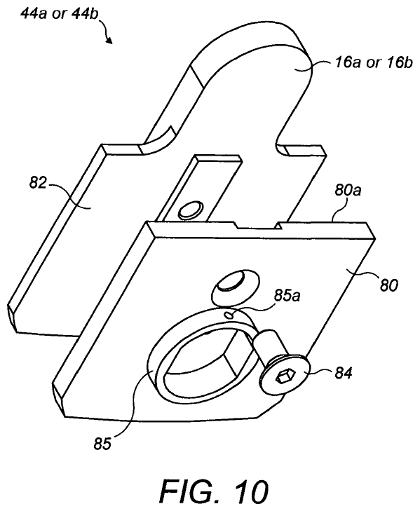

Referring to FIG. 10, the first retention assembly comprises a third plate part 80 having a spacing wall 80a, and a fourth plate part 82. The fourth plate part 82 is fixed to the third plate part 80 using a bolt 84, defining an interior space in which the limbs of a blade can be located. The fourth plate part 82 and the oscillating wall 16a are integrally formed. Although hidden in FIG. 10, the first retention assembly includes an annular spacing piece like the annular spacing piece 85. Like with the blade retention assembly shown in FIG. 9, a threaded hole is provided in the annular spacing piece and an overlying fitting 85, which enables a bolt (not shown) to be screwed therethrough and to fix the blade retention assembly in 44a to the corresponding sleeve. The second blade retention assembly 44b is configured in the same way as the first blade retention assembly 44a.

As seen in FIG. 2, a damping ring member 33a-d fits around a blade receiving side of each of the blade retention assemblies.

In operation of the sawing device, the drive shaft 12 causes the rotatable block 17 to rotate. The continuous groove 22 thus rotates, which causes the first, second, third and fourth linking balls 28a-d to move back and forth each in the corresponding support slots 24a-d. The movement of the linking balls 28-ad causes the linking walls 16a-d to oscillate back, and forth in a pivoting manner about a central axis of the corresponding sleeve 42a-d on which the linking wall 16a-d is mounted. Oscillating movement of the oscillating walls 16a-d causes rotational back and forth movement of the corresponding sleeve 42a-d and one or two blade retention assemblies 44a-f about the central axis of the corresponding sleeve 42a-d, thereby causing the blades to oscillate back and forth.

To remove a blade from one of the blade retention assemblies 44a-f, the corresponding pin 47a-d is first pushed into the corresponding sleeve 42a-d against the spring to move the pin 47a-d in the sleeve 42a-d from the blocking position, to the open position. The blade can then be removed from the blade retention assembly 44a-f by pulling of the blade away from the sawing device longitudinally relative to the limbs 58a,b. The first region 60 of the space between the limbs then passes through the corresponding slits in the sleeve and is detached. When released, the pin returns to its initial, blocking position through action of the spring.

To attach another blade, the pin the again pushed so dial the first portion 61 of the pin is not between the slits and the second portion 62 is, that is, the pin it in the open position. The limbs 58a,b can then be inserted into the interior space of the blade retention assembly, with a portion of the limbs passing through the slits and the cylindrical interior of the sleeve 42a-d The blade attachment part is then pushed until the base of the blade 59 abuts the sleeve, such that a part of the sleeve occupies the third region 64. The base of the blade 59 and the second region 67 are spaced so that, when the base abuts the sleeve, the second region 62 is positioned relative to the pin 47a-d so that on release of the pin 47a-d, the pin 47a-d returns to its blocking position extending through the second region 67, preventing detachment of the blade. This spacing facilitates insertion of the blade and prevents the blade being pushed in too far.

A drill bit attachment may be coupled or integrally formed with the drive shaft 12, such that an attached drill bit extends from the underside of the sawing device. An aperture 39 in the support structure 10 is provided to allow this. Thus, when the blades are pressed against the surface, the drill bit pierces the surface in a region to be cut out, thereby to anchor the cutting. This anchoring of cutting using a routing drill bit advantageously makes use of the presence of the drive draft.

The sawing device includes a detachable handle 70 and two mounts 71, 73 mounted on the support structure 10 to which the handle 70 can be attached. The mounts 71, 73 are positions so that the handle 70 can be mounted at relative right angles. The handle 70 is mounted to extend substantially radially relative to the central axis of the drive shaft 12. The handle 70 facilitates holding of the sawing device at a precise position for cutting. The two angles at which the handle can be attached each result in the handle extending substantially parallel or perpendicular to the direction of movement of the blades.

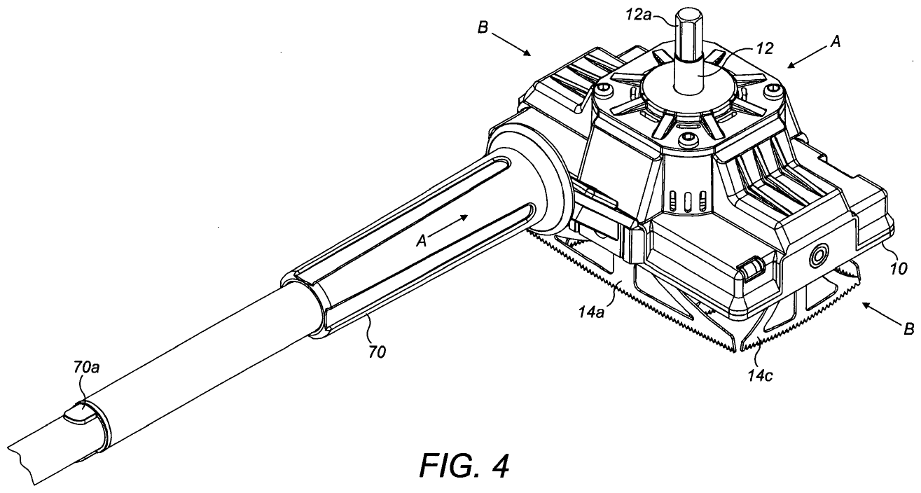

A measuring device for measuring a desired distance at which cutting is to take place is preferably provided and is collapsible within the handle A collapsing mechanism may comprise a plurality of cylindrical parts, which collapse using a telescoping mechanism, as indicated in FIG. 4, for example. Button 70a is resiliently depressable to collapse the handle. The measuring device may be configured for only measuring predetermined heights. For example, where the sawing device is to be used for sawing square or rectangular holes in walls for installation of plug sockets, regulations may require that they be at certain heights and the measuring device may be configured to enable measurement at those heights. The handle can be attached to the sawing device in any one of a variety of conventional ways, such that it does not detach in use. The handle is detachable, but in variant embodiments may be fixedly attached.

The convexly curved blades are highly advantageous for several reasons. They clear dust from a cut line like a circular saw, while producing cut lines of uniform depth. The curved blades also result in an array of cut lines being easy to produce with little force required by an operator to push the blades into a surface to be cut. In prior an cutting devices in which linear blades are used, there exists a problem that the devices bounce off the surface to be cut. This problem may be addressed with the pilot drill. However with the sawing device of the embodiment described above, the pilot drill is typically only useful where hard boards are being cut, or where the operator is new to the tool.

As can be seen in FIGS. 1 and 2, the outer housing 34 can be bolted to the support structure 10.

It will be appreciated by person skilled in the art that various modification are possible to the embodiments.

The sawing device described above allows attachment of a blade at six attachment places, so that, when blades of appropriate length are attached at the appropriate attachment places, the sawing device can be operated to cut lines in a square formation or a rectangular formation. In an alternative embodiment, the sawing device is configured with four blade attachment assemblies only, allowing attachment of the blades at only four places. In this case, cut lines in a square or a rectangular formation can be cut into the surface of an object to be cut.

Furthermore, advantages over prior an sawing devices derive from the creation of oscillatory motion, which is transmitted to the blades, together with the arcuate nature of the blade edges. Oscillators motion may be created using motion conversion mechanisms other than that described above.

The purpose of the arrangement of the continuous groove 22, the first, second, third and fourth support slots 24a-d, the first, second, third and fourth linking balls 28a-d and the first, second, third and fourth linking walls 26a-d is to transform rotational motion of the drive shaft 12 and thus the cylindrical block 17 into oscillating motion of the first, second, third and fourth linking walls 26a-d about the axes of the first, second, third and fourth sleeves 42a-d. As will be appreciated, modification to the arrangement described and shown is possible. The first, second, third and fourth slots need not necessarily be arranged so that the back and forth movement of the first, second, third and fourth linking balls 28a-d is parallel to the axis of the cylindrical block 20 and the drive shaft 14. The first, second, third and fourth slots may be non-parallel, but the continuous groove 22 and the first, second, third and fourth slots nevertheless arranged so that rotation of the cylindrical block causes back and forth movement of the first, second, third and fourth linking balls in the first, second, third and fourth support slots. The first, second, third and fourth support slots may even be curved. Also, the first, second, third and fourth force transmission grooves 30a-d may be at an angle relative to first, second, third and fourth slots other than that shown. The purpose of these parts is to cause back and forth angular oscillatory motion that can be transmitting to the saw blades.

The part-circular recesses that define live second region 62 need not be part circular. Instead they could be of many different shapes, provided that the corresponding pin can move to a blocking position to securely attach the blade. It is also not essential for the pins and or the sleeves to have circular cross-sections. The sleeve serves to transmit oscillatory motion and other shapes suffice to do this. Also, since cross-section of the sleeves is circular, the first portions of the pins are correspondingly shaped, but the interior shape of the sleeve and the outer shape of the pins may be different.

The applicant hereby discloses in isolation each individual feature or step described herein and any combination of two or more such features, to the extent that such features or steps or combinations of features and or steps are capable of being carried out based on the present specification as a whole in the light of the common general knowledge of a person skilled in the art, irrespective of whether such features or steps or combinations of features and or steps solve any problems disclosed herein, and without limitation to the scope of the claims. The applicant indicates that aspects of the present invention may consist of any such individual feature or step or combination of features and/or steps. In view of the foregoing description it will be evident to a person skilled in the an that various modifications may be made within the scope of the invention.

1. Apparatus comprising:
a rotatable drive shaft;
one or more members mounted for oscillatory, pivoting motion;
motion conversion means for converting rotational motion of the drive shaft to the oscillatory, pivoting motion of the one or more members;
means coupling the or each member and one or more saw blades so that the oscillatory motion of the one or more member causes oscillatory cutting action of the or each blade.

2. The apparatus of claim 1, wherein the motion conversion means comprises: a rotatable piece drivable by rotation of the drive shaft, and having a first linking means extending continuously and circumferentially around the rotatable piece in a wave-like manner;
a second linking means in or on the or each member;
one or more links for linking the or each first linking means and the or each second linking means, wherein the one or more first linking means, the one or more second linking means and the one or more links are configured to cooperate so that rotational motion of the rotatable piece causes the oscillating pivoting movement of the member.

3. The apparatus of claim 2, wherein the rotatable piece and the drive shaft are rotatable coaxially.

4. The apparatus of claim 2 or claim 3, wherein the first linking means is a groove extending continuously and circumferentially around the rotatable piece.

5. The apparatus of any one of claims 2 to 4, wherein the second linking means is a groove in the or each member.

6. The apparatus of claim 5, wherein the groove in the or each member extends non-radially with respect to a centre of the pivoting movement.

7. The apparatus of any one of claims 2 to 6, further comprising a respective support slot for guiding the or each link.

8. The apparatus of claim 7, wherein the or each support slot is arranging to guide the movement of the corresponding link, so that the movement is longitudinal with respect to a central axis of the rotatable piece.

9. The apparatus of any one of claims 2 to 8, further comprises a support means, wherein the rotatable piece and the drive shaft are mounted on the support means so as to enable rotational motion thereof, and the one or more members are also pivotably mounted on the support means.

10. The apparatus of claim 9, wherein the means coupling the or each member and the or each saw blade comprises a pivot piece mounted on the support means and to which the member and the or each blade are coupled, wherein the pivot piece extends away from the rotatable piece radially with respect to a central axis of the rotatable piece.

11. The apparatus of claim 10, wherein the blade can be coupled to the pivot piece at attachment places on the pivot piece that are different distances from the rotatable piece.

12. The apparatus of any one of claims 2 to 11, wherein the one or more members comprises four members, the one or more first linking means comprises four first linking means, the one or more second linking means comprises four second linking means, the one or more links comprises four links, the one or more means for coupling comprises four coupling means, and the one or more blades comprises four blades, wherein the four first linking means, the four second linking means and the four links are respectively configured to cooperate so that rotational motion of the rotatable piece causes the oscillating pivoting movement of the four members.

13. A saw blade for attaching to a sawing device including a first member and a second member, the saw blade comprising:
a cutting edge portion;
a mounting structure coupled with and spaced apart from the cutting edge portion, and configured for mounting of the saw blade on the sawing device using the first member and the second member;
wherein the mounting structure comprises first and second limbs joined at ends nearer the cutting edge portion by a base, and extending away from the cutting edge portion,
wherein the first and second limbs are arranged to provide a space between the limbs, wherein the space comprises:
a first region including an opening between free ends of the first and second limbs, and having a width of at least a first width;
a second region wider than the first width, such that, when the first member is located in the second region and the first member has a width greater than the first width, the saw blade cannot be separated from the mounting structure by movement longitudinal relative to a length of the first and second limbs;
a third region defined in part by the base, in which at least a part of the second member can be located, wherein the third region allows the at least a part of the second member to be located therein following movement of the at least a part of the second member through the first and second regions, wherein, in use, when the base abuts the second member, the second region is located in a predetermined location relative to the first member so that a least a portion of the first member having a width greater than the first width can locate in the second region.

14. The saw blade of claim 13, wherein the cutting edge is convex.

15. The saw blade of claim 13 or claim 14, wherein the cutting edge portion and the mounting structure are co-planar.

16. The saw blade of any one of claims 13 to 15, wherein the first and second limbs extend away from the cutting edge from a mid-region thereof in a transverse manner.

17. The saw blade of any one of claims 13 to 16, wherein the base of the mounting structure has a concave portion partially defining the third region, wherein the second member has a convex portion shaped for location flush against the concave portion.

18. The saw blade of claim 17, wherein the concave portion is part circular in cross-section.

19. The saw blade of any one of claims 13 to 18, wherein the third region has a width that is the same as a maximum width of the first region.

20. The saw blade of any one of claims 13 to 19, wherein the second region is defined by an opposing recess in each of the first and second limbs.

21. The saw blade of claim 20, wherein the recesses are concave and part-circular.

22. The saw blade of any one of claims 13 to 21, wherein the first region is provided between parallel inner edges of the first and second limbs.

23. The saw blade of any one of claims 13 to 22, wherein the first and second limbs have respectively outer edges and the saw blade is configured for location in a slot of width such that the outer edges abut against sides of the slot.

24. The saw blade of claim 23, wherein the outer edges are respectively parallel.

25. Apparatus comprising:
the saw blade of any one of claims 13 to 24;
the first member; and
the second member.

26. A kit comprising a plurality of blades each in accordance with any one of the claims 13 to 24.

27. The kit of claim 26, wherein the blades are of two different lengths.

28. A method of attaching a saw blade to a sawing device, wherein the sawing device has a first member and a second member, wherein the saw blade includes a mounting structure comprising a pair of limbs extending transversely relative to a cutting edge of the saw blade, wherein the pair of limbs define a space between the limbs, and wherein the first member is reconfigurable between a second width less than or equal to a first width and a third width greater than the first width, the method comprising:
operating the sawing device to configure the first member to have the second width;
relatively locating the saw blade and the first and second members, when the first member has the second width, by moving the first and second members longitudinally relative to the limbs through a first region of the space, which includes an opening between free ends of the limbs and has a minimum width of the first width, so that at least a part of the second member is located in a third region of the space, and the first member is located in a second region of the space;
operating the sawing device to reconfigure the first member to have the third width, whereby the blade cannot be separated from the mounting structure by movement longitudinal relative to the first and second limbs, and whereby the at least a part of the second member prevents movement of the first member into the third region.

29. The method of claim 28, further comprising a prior step of removing another blade including:
after the operating of the sawing device so that the first member has the second width, removing the blade by relative movement longitudinal relative to the limbs away from the sawing device.

30. The method of any one of claim 28 or claim 29, wherein the second member comprises a sleeve having a pair of slits on opposing sides thereof, wherein, when the saw blade and the first and second members are located in a first relative disposition, the parts of the limbs defining the first region slide through the slits and the sleeve abuts against the base of the saw blade.

31. The method of claim 30, wherein the first member comprises a pin located for sliding movement in the sleeve, wherein the pin is of the second and third widths at different positions along its length and can be moved longitudinally, wherein the operating the sawing device to reconfigure the second member to have the third width comprises moving the pin in the sleeve.

32. The method of claim 31, wherein the operating the sawing device to reconfigure the second member to have the third width comprises moving the pin in the sleeve against a resilient means.

33. The method of any one of claims 28 to 32, wherein the saw blade is the saw blade of any one of claims 13 to 24.

34. A sawing device comprising:
a rotatable drive shaft;
motion conversion means for converting rotational motion of the drive shaft to the oscillatory motion of a plurality of blades, wherein the blades are configured to simultaneously provide cut lines in a surface of an object to be cut in a square or rectangular formation;
a drill bit attachment rotatably coupled to the drive shaft, wherein, a drill bit, operatively attached to the drill bit attachment, is configured so that, when the blades are pressed against the surface, the drill bit pierces the surface thereby to anchor the sawing device when cutting.

35. A saw blade for attaching to a sawing device, comprising:
a convexly curved cutting edge portion;
a mounting structure coupled with and spaced apart from the cutting edge portion, wherein the saw blade is configured for cutting by oscillating motion about a pivot point in the mounting structure; wherein the cutting edge portion is shaped so that, when the saw blade is oscillated over a predetermined angle to cut into a flat surface, a cut line can be formed of substantially uniform depth.
